(19) United States
(12) Patent Application Publication
(10) Pub. No.: US 2007/0085692 A1
(43) Pub. Date: Apr. 19, 2007

(54) CARBON MONOXIDE DETECTOR ON A GAS POWERED GENERATOR

(75) Inventors: Jeffrey P. Grant, Forest Hill, MD (US); J. Michael Weaver, Stewartstown, PA (US); Dawei Chen, Forest Hill, MD (US)

Correspondence Address: HARNESS, DICKEY & PIERCE, P.L.C., P.O. BOX 828, BLOOMFIELD HILLS, MI, 48303, US

(73) Assignee: Black & Decker Inc., Newark, DE (US)

(21) Appl. No.: 11/550,199

(22) Filed: Oct. 17, 2006

Related U.S. Application Data
(60) Provisional application No. 60/728,411, filed on Oct. 19, 2005.

(51) Int. Cl. G08B 17/10

(52) U.S. Cl. 340/632

(57) ABSTRACT

A carbon monoxide detector is coupled to a gas-powered generator. The carbon monoxide detector is configured to provide notification when a predetermined concentration of carbon monoxide is reached and may also be utilized to disable the generator.

### CROSS-REFERENCE TO RELATED APPLICATIONS

This application claims the benefit of U.S. Provisional Application No. 60/728,411, filed on Oct. 19, 2005. The disclosure of the above application is incorporated herein by reference.

### TECHNICAL FIELD

The present disclosure relates to exhaust producing devices and more specifically to a gas-powered device having a carbon monoxide detector for alerting a user or disabling the device when detected levels of carbon monoxide exceed a predetermined level.

### BACKGROUND

Gas-powered devices are commonly found in residential and commercial areas. These devices typically emit some level of carbon monoxide containing exhaust. An example of such a device is a gas-powered generator. Gas-powered generators are used in areas ranging from commercial business places to residential homes and construction sites. When in use, these generators may be contained in some form of partially enclosed space or poorly ventilated open area. The enclosed or poorly ventilated nature of the spaces can result in a build-up of carbon monoxide concentration in the air. This concentration of carbon monoxide can eventually reach harmful levels. It is therefore desirable to have a method of detecting carbon monoxide coupled to a gas-powered device.

### SUMMARY

A carbon monoxide detector is coupled to a gas-powered generator. The carbon monoxide detector is configured to provide notification when a predetermined concentration of carbon monoxide is reached.

Further areas of applicability of the present disclosure will become apparent from the detailed description provided hereinafter. It should be understood that the detailed description and specific examples, while indicating exemplary implementation(s) of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an exemplary perspective view of a generator;

FIG. 1A is an exemplary schematic view of the control of the carbon monoxide detector; and

FIG. 2 is an exemplary flow chart showing the operation of the carbon monoxide detector coupled to the generator of FIG. 1.

### DETAILED DESCRIPTION

The following description is merely exemplary in nature and is in no way intended to limit the disclosure, its application, or uses.

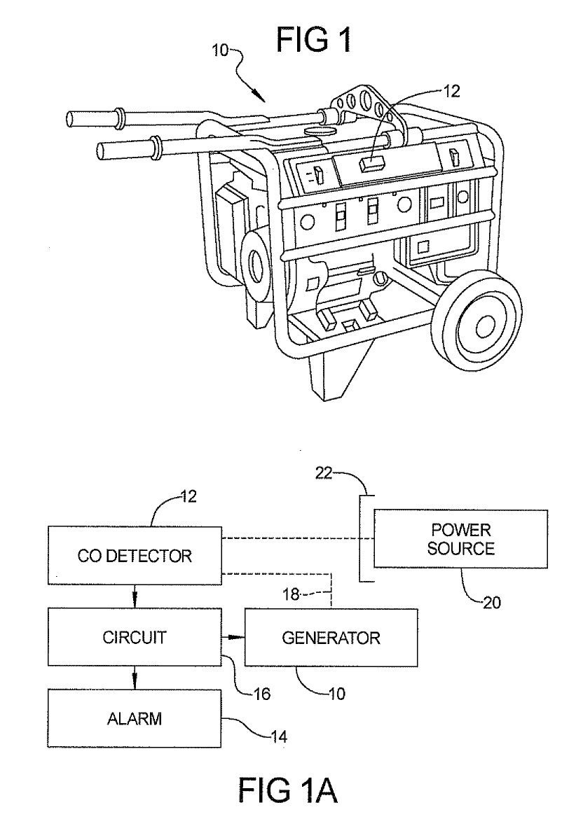

An exemplary gas-powered generator is shown in FIG. 1 at reference numeral 10. A carbon monoxide (CO) detector 12 is coupled to the generator 10. The generator 10, as is known in the art, includes a gas powered motor and an electrical generator system operably driven by the gas powered motor to generate electric power.

The CO detector 12 can be integrally mounted to the generator 10 as shown in FIG. 1. Alternatively, the CO detector 12 can be removable from the generator 10. In either configuration, the CO detector 12 provides notification when an unacceptable amount of CO is reached in an area occupied by the generator 10. The notification can occur in a variety of ways, discussed in greater detail below.

The CO detector 12 can also be integrated in a digital user information display that informs the user on a number of issues with the operation of the generator. For example, these issues can include undesirable CO level, low oil level and generated voltage level out of a desired range.

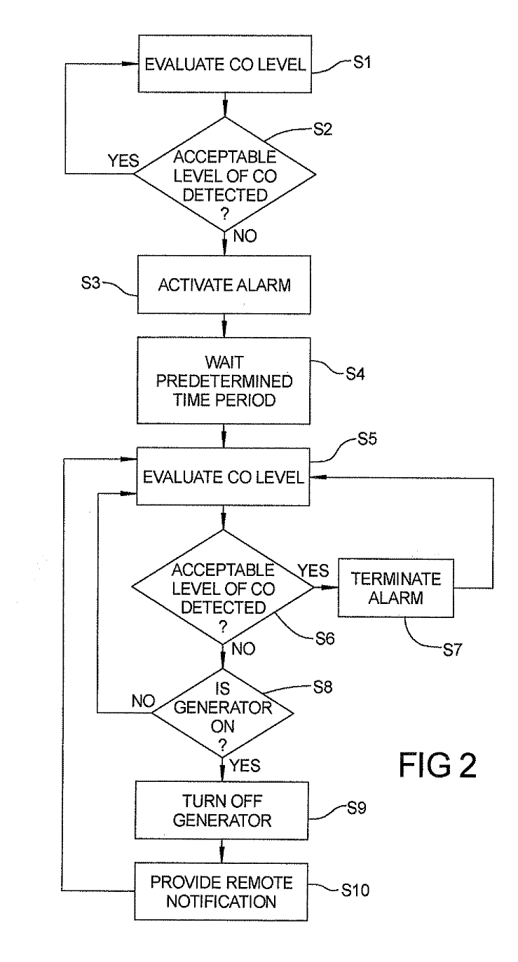

A flow chart showing the general operation of the carbon monoxide detector 12 is shown in FIG. 2. The start of operation is noted at step S1 by evaluating the CO level. The CO detector 12 can be powered independently from or by the generator 10. Referring to FIG. 1A, if powered by the generator 10, once the generator 10 is operating, the CO detector 12 can be powered on via electricity through power line 18. Alternatively, the CO detector 12 can be powered independently by an alternative source of power such as batteries. The CO detector 12 could alternately be powered by a combination of power supplied by the generator 10 and an alternative power source 20. Powering the CO detector 12 by an additional power source 20 can allow the CO detector 12 to serve as a CO detector for other devices producing CO exhaust in the area where the generator 10 is located, even when the generator 10 is not running. The power source 20 can be a rechargeable battery pack such as the type commonly used with power tools. The battery pack can be inserted into a cradle 22 mounted to the generator. During operation of the generator 10, the rechargeable battery pack can be re-charged by the generator 10 while received in the cradle 22 on the generator 10.

When analyzing the air in the surrounding space to determine CO content, the CO detector 12 determines whether an acceptable level of CO is present or if the level is beyond a predetermined limit, as indicated by step S2. The predetermined limit can be any amount of CO determined to warrant notification to the user.

If the CO detector 12 determines that the level of CO is acceptable, then the CO level continues to be monitored by the CO detector 12, as indicated by step S1. If the CO detector 12 determines that an unacceptable level of CO is reached, then an alarm 14, shown in FIG. 1A, can be activated as indicated in step S3. The alarm 14 can be any number of notifications to a user or other entity. For example, the alarm 14 can be audible. Alternatively, the alarm 14 can be visual, such as a flashing light. The alarm 14 can also be in the form of a hearing impaired warning device. The alarm 14 can provide remote notification as indicated at step S10, discussed in greater detail below. It should be noted that these alarm 14 types can be used individually or in any combination.

After activating the alarm 14, the CO detector 12 may wait a predetermined time period, as indicated at step S4, before proceeding to the next step S5 of evaluating the CO level again. The CO level may be evaluated once again at step S5. A determination may be reached as to whether an acceptable level of CO has been reached, indicated by step S6. This can be achieved by an operator opening a door or window or activating a fan or other air circulation device.

If the CO level is reduced to an acceptable level during the predetermined time period, then the CO detector 12 can terminate the alarm 14, indicated at step S7, and continue to monitor the air in the surrounding space, indicated at step S5. If the CO level is not reduced during the predetermined time period, the CO detector 12 can determine whether generator 10 is “ON”, indicated by step S8. If the generator 10 is on, it can be powered “OFF” by the CO detector 12, as indicated by step S9.

As previously noted, the CO detector 12 can automatically turn the generator 10 off if the predetermined CO level is reached. This can be achieved by the CO detector 12 connecting to a circuit 16, shown in FIG. 1A, on the generator 10 that shuts the generator 10 off at step S9. A dedicated circuit can be included for generator 10 shutdown, or logic control may be employed. The generator 10 may be shut down by a relay contact in the CO detector 12. Alternatively, the generator 10 may be turned off by a remote RF signal switching signal to a receiver in the generator 10. This feature can allow the generator 10 to be shut down without the need for the CO detector 12 to be directly coupled to the generator 10.

If the generator 10 is turned off, the CO detector 12 can still be operated if powered by an alternate power source, such as battery power. This way, the alarm 14 can still be active even after the generator has been shut down. This would allow the CO detector 12 to provide notifications as previously noted and/or to continue the alarm 14 mechanism in the vicinity of the generator 10 until an acceptable level of CO is reached. The CO detector 12 can also prevent the restarting of the generator 10 until an acceptable CO level is reached.

The CO detector 12 can then provide some form of remote notification, as indicated by step S10. This can be achieved through the CO detector 12 calling a predetermined phone number (land line or cell phone). The remote notification can also be achieved through a wireless infrared or RF device, contacting users or some other media (such as a computer) at the remote location. This can allow automatic contact with police departments, fire departments, home security companies, or any other contact. In one exemplary implementation, the CO detector 12 may provide multiple remote notifications. The multiple remote notifications may be performed according to a priority notification sequence.

While discussed above in relation to a generator 10, it should be appreciated that the present disclosure may be incorporated into any of a number of different devices. These devices can include any other gasoline-powered products such as compressors, pressure washers, pumps, saws, heaters and welders. This provides an alert to a user of dangerous levels of CO. The user is then able to make changes to the placement of the device and/or leave the work area to ensure safety. It should also be noted that the steps can be rearranged and some may even be eliminated and still be within the scope of the disclosure.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A gas powered generator, comprising:
a gas-powered motor producing an exhaust;
a generator system operably driven by said gas-powered motor to generate electric power;
a carbon monoxide detector configured to determine a carbon monoxide content in a vicinity of said generator; and
an alarm device responsive to said carbon monoxide detector for indicating to a user that the carbon monoxide content in the vicinity of said generator has exceeded a predetermined level.

2. The generator according to claim 1, further comprising a control mechanism responsive to said carbon monoxide detector for disabling said gas-powered motor when the carbon monoxide content in the vicinity of said generator has exceeded a predetermined level.

3. The generator according to claim 1, wherein said carbon monoxide detector includes a battery power source.

4. The generator according to claim 3, wherein said generator includes a cradle for receiving said battery power source.

5. The generator according to claim 4, wherein said cradle is adapted to charge said battery power source with electricity generated by said generator.

6. The generator according to claim 1, wherein said carbon monoxide detector is powered by said generator system.

7. A gas powered generator, comprising:
a gas-powered motor producing an exhaust;
a generator system operably driven by said gas-powered motor to generate electric power;
a carbon monoxide detector configured to determine a carbon monoxide content in a vicinity of said generator; and
an alarm device responsive to said carbon monoxide detector for indicating to a user that the carbon monoxide content in the vicinity of said generator has exceeded a predetermined level.

8. The generator according to claim 7, wherein said carbon monoxide detector includes a battery power source.

9. The generator according to claim 8, wherein said generator includes a cradle for receiving said battery power source.

10. The generator according to claim 9, wherein said cradle is adapted to charge said battery power source with electricity generated by said generator.

11. The generator according to claim 7, wherein said carbon monoxide detector is powered by said generator system.
